(19) United States
(12) Patent Application Publication
(10) Pub. No.: US 2026/0195705 A1
(43) Pub. Date: Jul. 9, 2026

(54) STORAGE WORK ASSISTANCE DEVICE, STORAGE WORK ASSISTANCE METHOD, AND PROGRAM

(71) Applicant: JGC CORPORATION, Yokohama-shi, Kanagawa (JP)

(72) Inventors: Jumpei TAMAI, Yokohama-shi (JP); Kei YAMADA, Yokohama-shi (JP); Hideyuki IKUTA, Yokohama-shi (JP); Koichi YAMAZAKI, Yokohama-shi (JP); Daichi HATANAKA, Yokohama-shi (JP)

(73) Assignee: JGC CORPORATION, Yokohama-shi, Kanagawa (JP)

(21) Appl. No.: 18/863,892

(22) PCT Filed: May 11, 2022
(86) PCT No.: PCT/JP2022/019953

§ 371 Date: Nov. 7, 2024

(51) Int. Cl. G06Q 10/087

(52) U.S. Cl. CPC G06Q 10/087

(57) ABSTRACT

According to one aspect of the present invention, provided is a storage work support device including: a storage work information acquisition unit configured to acquire storage work information including one or more pieces of storage work; a type associating unit configured to associate a type of an object that becomes a target of storage work with the storage work information; a storage work associating unit configured to associate storage work included in the storage work information associated with the type of the object with the object as storage work for the object; a receipt date acquisition unit configured to acquire a date on which the object has been received; and a notification unit configured to notify a schedule of execution of the storage work associated with the object in accordance with the date acquired by the receipt date acquisition unit.

### CROSS-REFERENCE TO RELATED APPLICATION

This application is the National Stage filing under 35 U.S.C. 371 of International Application No. PCT/JP2022/019953, filed May 11, 2022, which is incorporated by reference in its entirety.

### TECHNICAL FIELD

The present invention relates to technologies of a storage work support device, a storage work support method, and a program.

### BACKGROUND ART

Objects such as equipment and materials used at a construction site are required to be stored in a favorable state.

### Citation List

### Patent Literature

[PTL 1] JP 2009-215075 A

### SUMMARY OF INVENTION

### Technical Problem

The content of work for storing an object in a favorable state differs depending on each object. In addition, even the same work often differs in the cycle of execution of the work. Such a cycle is required to be calculated on the basis of the date on which the object has been received. As described above, many factors are involved in storing the object in a favorable state. Therefore, it has been difficult to store the object in a favorable state.

In view of the above-mentioned circumstances, an object of the present invention is to provide a technology for supporting work of storing an object in a favorable state.

### Solution to Problem

According to one aspect of the present invention, there is provided a storage work support device including: a storage work information acquisition unit configured to acquire storage work information including one or more pieces of storage work; a type associating unit configured to associate a type of an object that becomes a target of storage work with the storage work information; a storage work associating unit configured to associate storage work included in the storage work information associated with the type of the object with the object as storage work for the object; a receipt date acquisition unit configured to acquire a date on which the object has been received; and a notification unit configured to notify a schedule of execution of the storage work associated with the object in accordance with the date acquired by the receipt date acquisition unit.

According to one aspect of the present invention, there is provided a storage work support method including: a storage work information acquisition step of acquiring storage work information including one or more pieces of storage work; a type associating step of associating a type of an object that becomes a target of storage work with the storage work information; a storage work associating step of associating storage work included in the storage work information associated with the type of the object with the object as storage work for the object; a receipt date acquisition step of acquiring a date on which the object has been received; and a notification step of notifying a schedule of execution of the storage work associated with the object in accordance with the date acquired in the receipt date acquisition step.

According to one aspect of the present invention, there is provided a program for causing a computer to function as: a storage work information acquisition unit configured to acquire storage work information including one or more pieces of storage work; a type associating unit configured to associate a type of an object that becomes a target of storage work with the storage work information; a storage work associating unit configured to associate storage work included in the storage work information associated with the type of the object with the object as storage work for the object; a receipt date acquisition unit configured to acquire a date on which the object has been received; and a notification unit configured to notify a schedule of execution of the storage work associated with the object in accordance with the date acquired by the receipt date acquisition unit.

### Advantageous Effects of Invention

According to the present invention, it is possible to support the work of storing an object in a favorable state.

### BRIEF DESCRIPTION OF DRAWINGS

FIG. 1 is a diagram for illustrating one example of a functional configuration of a storage work support device.

FIG. 2 is a table for showing one example of a storage form.

FIG. 3 is a table for showing one example of storage work.

FIG. 4 is a table for showing one example of work-related information.

FIG. 5 is a table for showing one example of storage form-object type.

FIG. 6 is a table for showing one example of an object type.

FIG. 7A is a table for showing one example of storage work-object type.

FIG. 7B is a table for showing one example of object-storage place.

FIG. 7C is a table for showing one example of storage work-storage place.

FIG. 8 is a table for showing one example of object-related information.

FIG. 9 is a table for showing one example of a stage.

FIG. 10 is a table for showing one example of storage work information.

FIG. 11 is a diagram for schematically illustrating associating by the storage work support device.

FIG. 12 is a flowchart for illustrating a flow of processing relating to the associating.

FIG. 13 is a flowchart for illustrating a flow of notification processing.

FIG. 14 is a diagram for illustrating a notification example of a schedule.

FIG. 15 is a diagram for schematically illustrating associating of a storage place with storage work.

FIG. 16 is a flowchart for illustrating a flow of extraction processing.

FIG. 17 is a table for showing an extracted information example.

FIG. 18 is a flowchart for illustrating a flow of tracking processing.

FIG. 19 is a table for showing one example of a tracking list.

### DESCRIPTION OF EMBODIMENTS

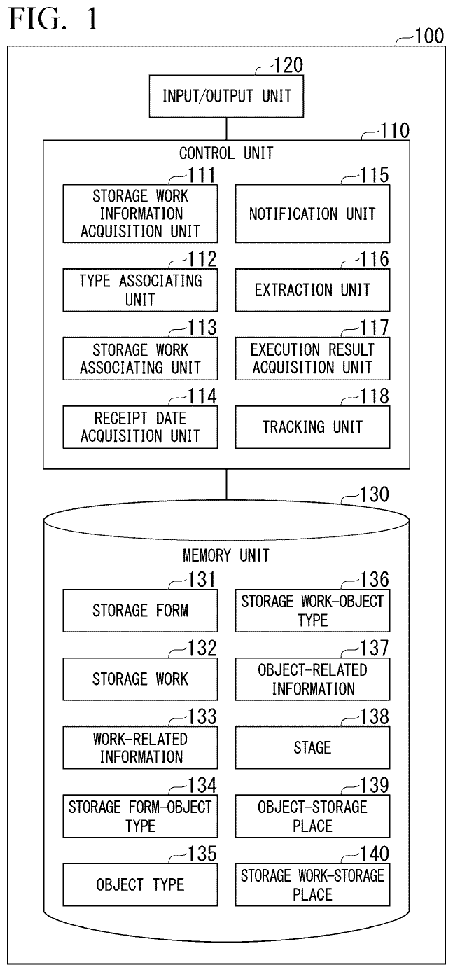

FIG. 1 is a diagram for illustrating one example of a functional configuration of a storage work support device 100. The storage work support device 100 includes a control unit 110, an input/output unit 120, and a memory unit 130. For example, those components are implemented by execution of a program (software) by a hardware processor such as a central processing unit (CPU). Part or all of those components may be implemented by hardware (circuit unit; including circuitry) such as a large scale integration (LSI), an application specific integrated circuit (ASIC), a field-programmable gate array (FPGA), or a graphics processing unit (GPU), or may be implemented by cooperation between software and hardware. The program may be stored in advance in a memory device (memory device including a non-transitory memory medium) such as a hard disk drive (HDD), a solid state drive (SSD), or a flash memory. Alternatively, the program may be stored in an attachable/detachable memory medium (non-transitory memory medium) such as a DVD or a CD-ROM and be installed through mounting of the memory medium in a drive device.

The input/output unit 120 executes inputting and outputting of various kinds of information. The various kinds of information include information input from an operator of the storage work support device 100, information output (displayed) to the operator, information transmitted and received through communication, and the like.

The memory unit 130 includes a memory device such as an HDD, an SSD, or a flash memory. The memory unit 130 stores a storage form 131, storage work 132, work-related information 133, storage form-object type 134, an object type 135, storage work-object type 136, object-related information 137, a stage 138, object-storage place, and storage work-storage place. Those various kinds of information are described.

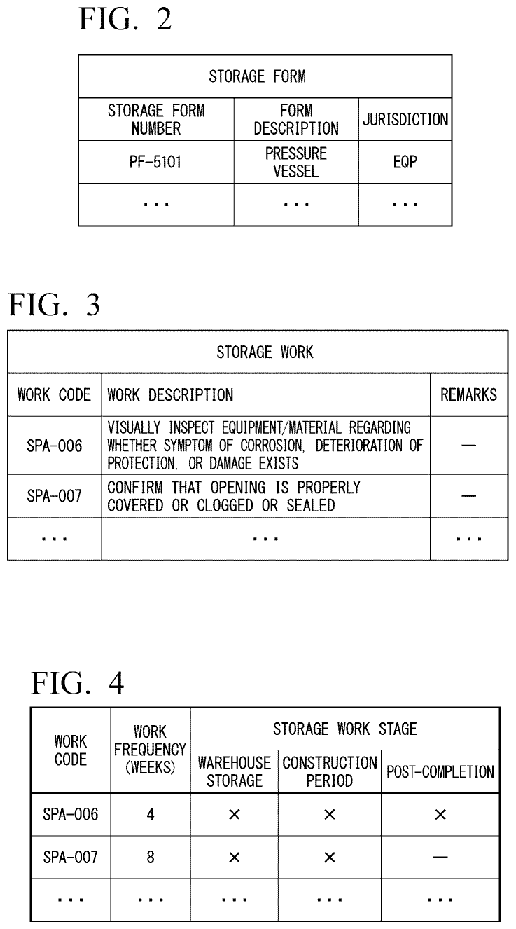

FIG. 2 is a table for showing one example of the storage form 131. As illustrated in FIG. 2, the storage form 131 is information for grouping of storage work on the basis of the object, and is information in which pieces of information on a storage form number, form description, jurisdiction, and the like are associated with each other. The storage form number is information to uniquely identify the storage form. The form description is description of the object. The jurisdiction shows jurisdiction relating to storage of the object.

FIG. 3 is a table for showing one example of the storage work 132. As shown in FIG. 3, the storage work 132 shows the content of storage work and is information in which pieces of information on a work code, work description, remarks, and the like are associated with each other. The work code is information to uniquely identify the storage work. The work description shows the content of work. The remarks show remarks regarding the storage work. The “storage work” as used in this embodiment refers to work for storing an object in a favorable state and includes also various kinds of work for storing an object in a favorable state, such as preservation work and maintenance work. In the following embodiment, “storage work” may sometimes be referred to simply as “work.”

FIG. 4 is a table for showing one example of the work-related information 133. As shown in FIG. 4, the work-related information 133 shows the frequency of execution of work and the current storage work stage, and is information in which pieces of information on the above-mentioned work code, the work frequency (weeks), the storage work stage, and the like are associated with each other. The work frequency (weeks) is information showing the work frequency in units of week. For example, when the work frequency (weeks) is 1, this indicates that work is executed every other week. When the work frequency (weeks) is 2, this indicates that work is executed every third week. The storage work stage shows the stage at which the object is put. In this embodiment, as one example, it is assumed that the objects are used for construction. Further, this embodiment uses three storage work stages: “warehouse storage” at which the object is stored in a warehouse before the construction; “construction period” at which the construction is being executed; and “post-completion” at which the construction period has ended. In the following description, the “storage work stage” may sometimes be expressed simply as the “stage.”

In general, when the stage differs, whether or not to execute work for the object and the content of work also differ in many cases. Thus, execution of appropriate storage work is enabled by setting whether or not to execute the content of work at each stage for each work code in this manner. For example, in the case of FIG. 4, “x” indicates that work is executed, and “-” indicates that work is not executed. Therefore, it is indicated that work of a work code SPA-006 is executed at all storage work stages.

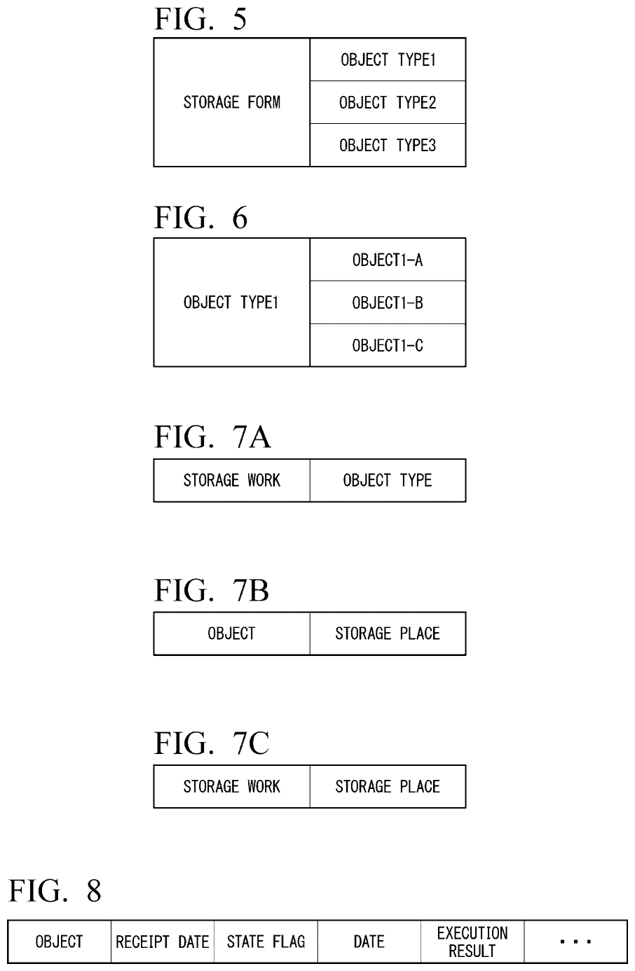

FIG. 5 is a table for showing one example of the storage form-object type 134. As shown in FIG. 5, the storage form-object type 134 is information in which pieces of information on the storage form, the object type, and the like are associated with each other. One or more object types are associated with the storage form. The object type shows the type of the object. For example, the type of the object includes names in terms of high-level concept, such as a tire and a pump, for classifying the object.

FIG. 6 is a table for showing one example of the object type 135. As shown in FIG. 6, the object type 135 is information in which pieces of information on the object type, the object, and the like are associated with each other. The object type 135 is information in which the object type is associated with the objects that belong to this object type. For example, when an object type 1 is the pump, a centrifugal pump, a propeller pump, and a viscous pump are given as an object 1-A, an object 1-B, and an object 1-C, respectively.

FIG. 7A is a table for showing one example of the storage work-object type 136. As shown in FIG. 7A, the storage work-object type 136 is information in which pieces of information on the storage work, the object type, and the like are associated with each other. For example, the storage work-object type 136 is information in which the pump is associated with the storage work for the pump.

FIG. 7B is a table for showing one example of the object-storage place 139. As shown in FIG. 7B, the object-storage place 139 is information in which pieces of information on the object, the storage place, and the like are associated with each other. For example, objects at a plant construction site include objects for which the attachment position is not particularly settled. For example, the attachment position is settled for pumps and static equipment, but the attachment position is not settled for piping members such as piping valves and instrumentation products such as instrumentation valves. There are such objects that do not have information relating to the attachment position. The object-storage place 139 is information that associates such objects with the storage place.

FIG. 7C is a table for showing one example of the storage work-storage place 140. As shown in FIG. 7C, the storage work-storage place 140 is information in which pieces of information on the storage work, the storage place, and the like are associated with each other. The storage work-storage place 140 is information that associates the storage work for the object that does not have the above-mentioned information relating to the attachment position with the storage place.

FIG. 8 is a table for showing one example of the object-related information 137. As shown in FIG. 8, the object-related information 137 is information in which pieces of information on the object, the receipt date, a state flag, the date, an execution result, and the like are associated with each other. For example, the object-related information 137 is information in which a pump, the date on which the pump has been received, the state of the pump, the date on which storage work has been executed, and the execution result of the storage work are associated with each other. The object-related information 137 is set for each object. The state flag is a flag indicating whether or not the storage state is a specific state (for example, defective state). The state flag becomes a flag indicating a specific state in the case in which the storage state has become the specific state even once. As the execution result, text or image data obtained by imaging the object can be stored.

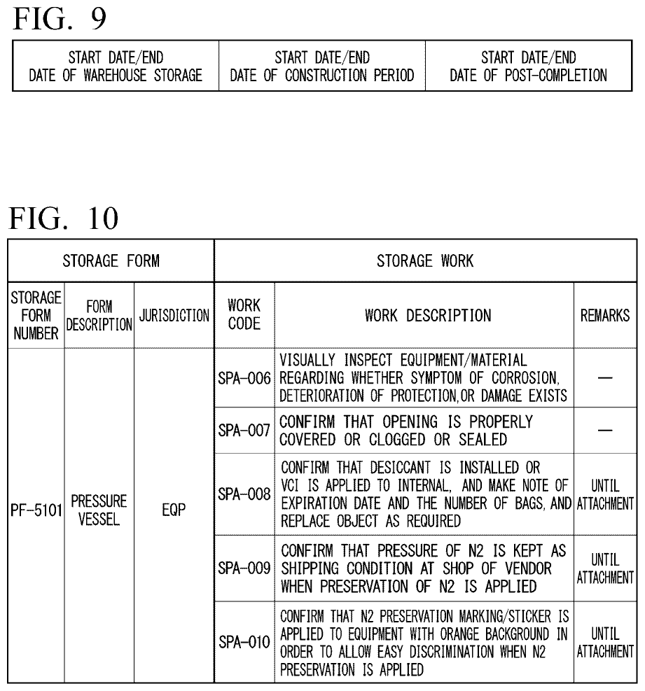

FIG. 9 is a table for showing one example of the stage 138. As shown in FIG. 9, the stage 138 is information showing the start date and the end date of the warehouse storage, the start date and the end date of the construction period, and the start date and the end date of the post-completion. For the stage 138, for example, the storage work stage input by a worker of the storage work support device 100 may be received by the input/output unit 120 and be stored in the stage 138. Alternatively, the stage 138 may be acquired from software that manages steps. Moreover, the stage 138 may be set for each object.

FIG. 10 is a table for showing one example of storage work information. The storage work information is information in which the above-mentioned storage form is associated with storage work. It is assumed that the storage form 131 and the storage work 132 are associated with each other in advance to be stored in the memory unit 130. A plurality of pieces of storage work are associated with one storage form in some cases as illustrated in FIG. 5. As described above, the storage work information includes one piece of storage work.

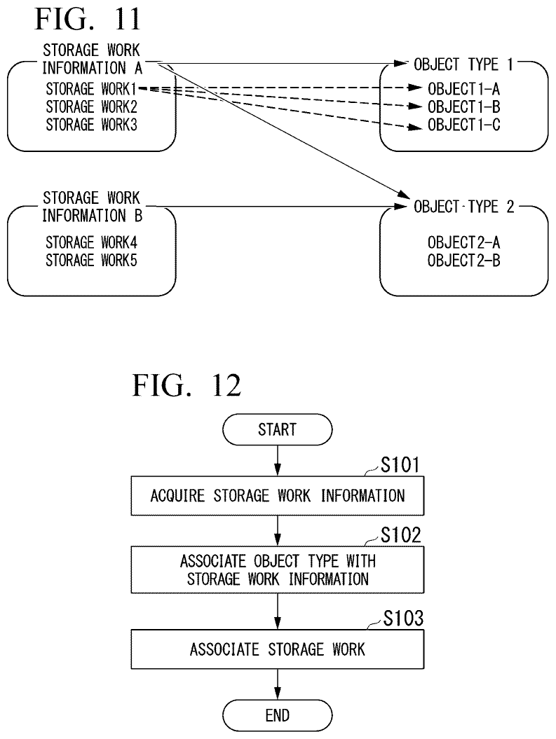

Referring back to FIG. 1, the control unit 110 supports work of storing the object in a favorable state by controlling the respective units of the storage work support device 100. The control unit 110 includes a storage work information acquisition unit 111, a type associating unit 112, a storage work associating unit 113, a receipt date acquisition unit 114, a notification unit 115, an extraction unit 116, an execution result acquisition unit 117, and a tracking unit 118. Those units are described also with reference to FIG. 11.

FIG. 11 is a diagram for schematically illustrating associating by the storage work support device 100. In FIG. 11, pieces of storage work information A and B and object types 1 and 2 are illustrated. Pieces of storage work 1 to 3 are included in the storage work information A. Pieces of storage work 4 and 5 are included in the storage work information B. Objects 1-A, 1-B, and 1-C are included in the object type 1. Objects 2-A and 2-B are included in the object type 2.

The storage work information acquisition unit 111 acquires the storage work information including one or more pieces of storage work like that shown in FIG. 10. The type associating unit 112 associates the type of the object that becomes the target of the storage work with the storage work information. For example, as illustrated in FIG. 11, the type associating unit 112 associates the storage work information A with the object types 1 and 2 and associates the storage work information B with the object type 2.

The storage work associating unit 113 associates the storage work included in the storage work information associated with the type of the object with the object as the storage work for the object. For example, as illustrated in FIG. 11, the storage work associating unit 113 associates the storage work 1 included in the storage work information A with the objects 1-A, 1-B, and 1-C included in the object type 1 as the storage work for the objects 1-A, 1-B, and 1-C.

The receipt date acquisition unit 114 acquires the date on which the object has been received. For example, the receipt date acquisition unit 114 receives, by the input/output unit 120, a date input by a worker of the storage work support device 100 and stores the date in the object-related information 137. The notification unit 115 notifies the schedule of execution of the storage work associated with the object in accordance with the date acquired by the receipt date acquisition unit 114.

When a predetermined timing is specified, the extraction unit 116 extracts the storage work to be executed at the specified predetermined timing and the object for which this storage work is to be executed. Specific extraction processing is described later. The execution result acquisition unit 117 acquires the execution result of the storage work. The acquired execution result is stored in the execution result of the object-related information 137. The execution result includes the storage state of the object. The tracking unit 118 tracks the object having the storage state being is the specific state. Specific tracking processing is described later.

FIG. 12 is a flowchart for illustrating a flow of processing relating to the above-mentioned associating. In FIG. 12, the storage work information acquisition unit 111 acquires the storage work information including one or more pieces of storage work (Step S101). The type associating unit 112 associates the type of the object that becomes the target of the storage work with the storage work information (Step S102). The storage work associating unit 113 associates the storage work included in the storage work information associated with the type of the object with the object as the storage work for the object (Step S103), and ends the processing.

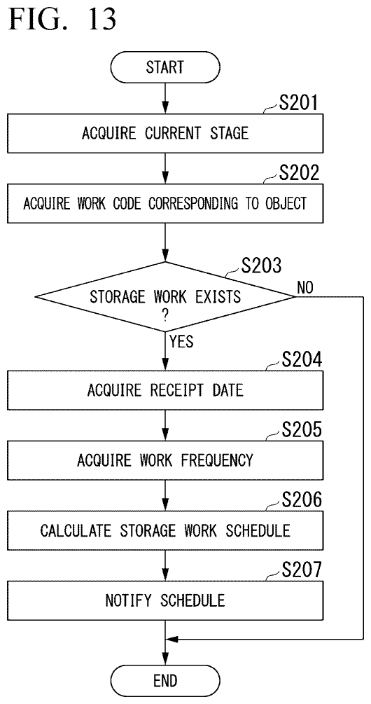

Next, notification processing executed by the notification unit 115 is described. FIG. 13 is a flowchart for illustrating a flow of the notification processing executed by the notification unit 115. This flowchart shows processing of notifying the schedule of management work for one object. Therefore, in a case of notifying the schedule for a plurality of objects, the same number of loops as the number of objects are executed.

The notification unit 115 acquires the current stage from the stage 138 (Step S201). The notification unit 115 acquires the work code corresponding to the object (Step S202). As described above, the storage work included in the storage work information associated with the type of the object has been associated by the storage work associating unit 113 with the object as the storage work for the object.

The notification unit 115 determines whether or not storage work exists at the current stage (Step S203). The work code is associated with the storage work stage in the above-mentioned work-related information 133. Thus, the notification unit 115 can determine whether or not the storage work exists at the current stage by acquiring the work-related information 133 from the memory unit 130.

When the storage work does not exist (Step S203: NO), the notification unit 115 ends the processing. When the storage work exists (Step S203: YES), the notification unit 115 acquires the receipt date of the object from the object-related information 137 (Step S204), and acquires the work frequency from the work-related information 133 (Step S205).

The notification unit 115 calculates the schedule of execution of the storage work from the receipt date and the work frequency (Step S206), and notifies the schedule obtained by the calculation (Step S207), to end the processing.

One example of the method of calculating the schedule of execution of storage work is described. For example, days are divided in units of seven days, with the receipt date being the starting point. When the work frequency (weeks) is N (executed every N+1-th week), the N+1-th week, the 2(N+1)-th week, . . . , the k(N+1)-th week (k is an integer equal to or larger than 1) from the receipt date, that is, weeks of integer multiples of N+1, are set as the dates on which the storage work is to be executed.

Days may be divided in units of seven days in advance irrespective of the receipt date and weeks of integer multiples of N+1 from the week to which the receipt date belongs may be set as the dates on which the storage work is to be executed. For example, when days are divided into 4/1 to 7, 8 to 15, and 16 to 23 in advance, in the case of the object that has been received on 4/1 to 7 and has the same work frequency (weeks), the schedule of execution of storage work is the same schedule even when the receipt date is different. Moreover, the stage changes as described above and the storage work also differs on each stage basis. Thus, the date on which the stage has changed also corresponds to the receipt date.

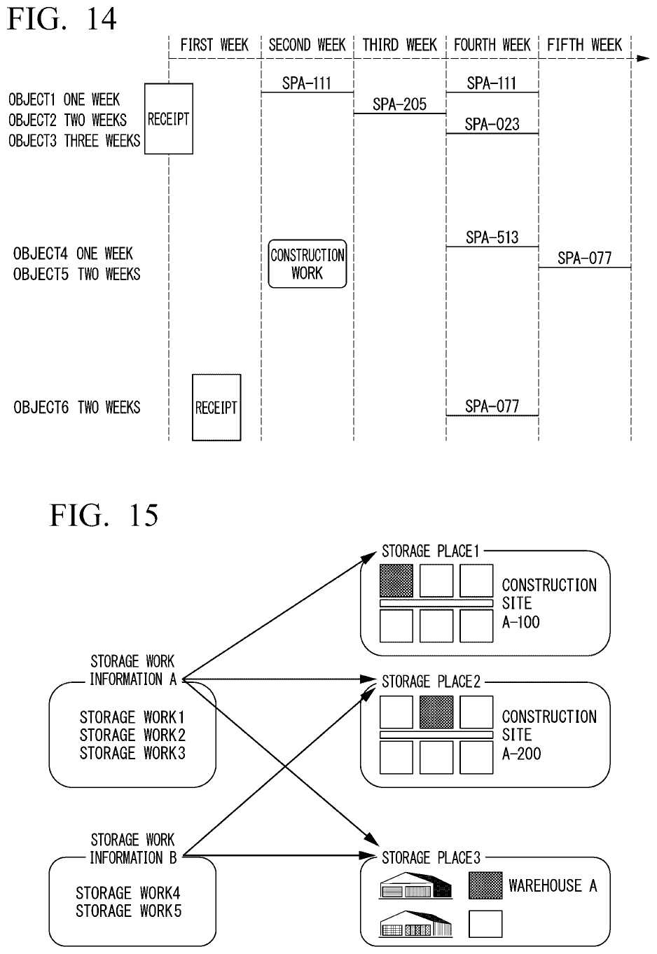

FIG. 14 is a diagram for illustrating a notification example of the schedule. In FIG. 14, the schedule of pieces of storage work for objects 1 to 6 is indicated by horizontal bars together with the work codes. In this manner, the notification unit 115 notifies information (work codes) indicating the pieces of storage work together with the schedule. In FIG. 14, the receipt date of the objects 1 to 3 is set at the beginning of the first week, and the receipt date of the object 6 is set at the middle of the first week. Regarding the objects 4 and 5, the stage has changed due to the start of construction work in the second week. Moreover, as one example, the work frequency (weeks) of the objects 1 and 4 is set to one week. The work frequency (weeks) of the objects 2, 5, and 6 is set to two weeks. The work frequency (weeks) of the object 3 is set to three weeks.

In this case, it is indicated that the date of the storage work for the object 1 is in the second week, and it is indicated that the date of the storage work for the object 2 is in the third week. Further, it is indicated that the dates of the pieces of storage work for the objects 1, 3, 4, and 6 are in the fourth week. In addition, it is indicated that the date of the storage work for the object 5 is in the fourth week.

The notification in this manner allows the person who executes the storage work to recognize the schedule and execute the storage work in accordance with this schedule. Thus, a technology for supporting work of storing the object in a favorable state can be provided.

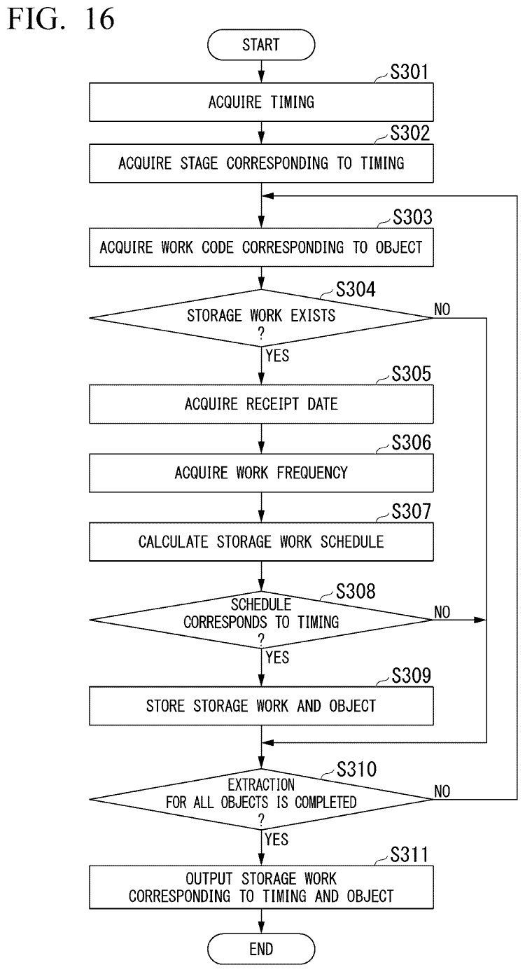

FIG. 15 is a diagram for schematically illustrating associating of the storage place with storage work. In FIG. 15, pieces of storage work information A and B and storage places 1, 2, and 3 are illustrated. Pieces of storage work 1 to 3 are included in the storage work information A. Pieces of storage work 4 and 5 are included in the storage work information B.

In FIG. 15, the storage work information A is associated with the storage place 1. The pieces of storage work information A and B are associated with the storage place 2. The pieces of storage work information A and B are associated with the storage place 3. As described above, in this embodiment, the associating can be switched in accordance with whether or not the object that becomes the target of the storage work has information relating to the attachment position at the construction site. As a result of this configuration, it is possible to deal with the case in which personnel are insufficient to manage each object, such as the case of a small-scale project or module yard, for example.

Next, description is given of processing of extracting the storage work to be executed at a specified predetermined timing and the object for which this storage work is to be executed when the predetermined timing is specified. FIG. 16 is a flowchart for illustrating a flow of the extraction processing executed by the extraction unit 116.

The extraction unit 116 acquires a timing (Step S301). This timing is a week or a date, for example. The timing specified by an operator is acquired. The extraction unit 116 acquires the stage corresponding to the timing from the stage 138 (Step S302). The start date and the end date of each stage are recorded in the stage 138 as described above, and hence the extraction unit 116 can acquire the stage corresponding to the timing.

Next, the extraction unit 116 acquires the work code corresponding to an object (Step S303). As described above, the storage work included in the storage work information associated with the type of the object has been associated by the storage work associating unit 113 with the object as the storage work for the object. Further, in this processing, the extraction processing is executed for all objects.

The extraction unit 116 determines whether or not storage work exists at the corresponding stage (Step S304). The work code is associated with the storage work stage in the above-mentioned work-related information 133. Thus, the notification unit 115 can determine whether or not storage work exists at the corresponding stage by acquiring the work-related information 133 from the memory unit 130.

When storage work does not exist (Step S304: NO), the extraction unit 116 advances the process to Step S310. When storage work exists (Step S304: YES), the notification unit 115 acquires the receipt date of the object from the object-related information 137 (Step S305), and acquires the work frequency from the work-related information 133 (Step S306).

The notification unit 115 calculates the schedule of execution of the storage work from the receipt date and the work frequency (Step S307), and determines whether or not the schedule corresponds to the timing specified by the operator (Step S308). When the schedule does not correspond to the timing specified by the operator (Step S308: NO), the extraction unit 116 advances the process to Step S310. When the schedule corresponds to the timing specified by the operator (Step S308: YES), the extraction unit 116 stores the storage work and the object (Step S309).

The extraction unit 116 determines whether or not the extraction processing for all objects has been completed (Step S310). When the extraction processing for all objects has not been completed (Step S310: NO), the extraction unit 116 advances the process to Step S303 to execute the processing for the object for which the extraction processing has not been executed. When the extraction processing for all objects has been completed (Step S310: YES), the extraction unit 116 outputs the storage work stored in Step S309 and the object for which the storage work is to be executed (Step S311), to end the processing.

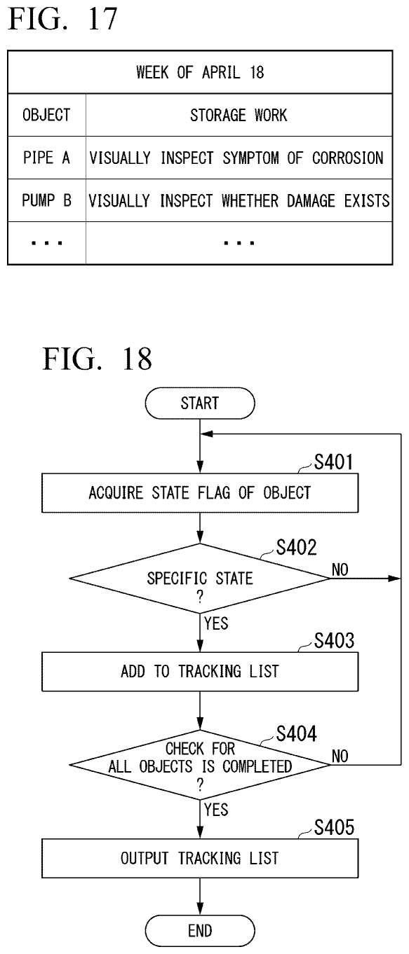

FIG. 17 is a table for showing an extracted information example obtained by the extraction processing. FIG. 17 shows a timing (week of April 18) specified by an operator, objects, and storage work for the objects. With this configuration, the operator can check, at a glance, the storage work that should be executed at the specified timing and the object for which the storage work is to be executed. As a result, the schedule of workers can easily be planned, and thus operation with high efficiency can be executed.

Next, processing of tracking the object having the storage state being the specific state is described. FIG. 18 is a flowchart for illustrating a flow of the tracking processing executed by the tracking unit 118. This extraction processing is executed for all objects. The tracking unit 118 acquires the state flag of the object-related information 137 corresponding to an object (Step S401). The tracking unit 118 determines whether or not the acquired state flag is a flag indicating the specific state (Step S402). When the state flag does not indicate the specific state (Step S402: NO), the tracking unit 118 advances the process to Step S404.

When the state flag indicates the specific state (Step S402: YES), the tracking unit 118 adds the object-related information of the object to a tracking list. The tracking unit 118 determines whether or not the check of the state flag has been completed for all objects (Step S404). When the check for all objects has not been completed (Step S404: NO), the tracking unit 118 advances the process to Step S401 to execute the processing for the object for which the check of the state flag has not been executed. When the check for all objects has been completed (Step S404: YES), the tracking unit 118 outputs the tracking list (Step S404), and ends the processing.

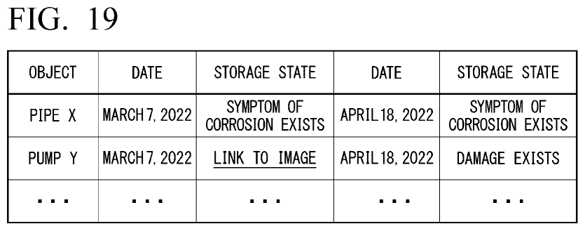

FIG. 19 is a table for showing one example of the tracking list output by the tracking processing. In the tracking list shown in FIG. 19, dates and the storage state on the dates are shown for each object. The storage state is shown by text or image data obtained by imaging the object as described above. For example, the storage state of pipe X on Mar. 7, 2022 is shown by text as “symptom of corrosion exists.” The storage state of pump Y on Mar. 7, 2022 is shown by a link to an image. When the link is selected, the image is displayed.

Outputting the tracking list in this manner allows tracking of the storage state across all storage work stages (“warehouse storage,” “construction period,” and “post-completion”), for example.

Although the embodiment of the present invention has been described in detail above with reference to the drawings, specific configurations are not limited to this embodiment and design and the like within such a range as not to depart from the gist of the present invention are also included.

### Industrial Applicability

The present invention can be applied to a technology for supporting work of storing an object in a favorable state.

### Reference Signs List

100 storage work support device
110 control unit
111 storage work information acquisition unit
112 type associating unit
113 storage work associating unit
114 receipt date acquisition unit
115 notification unit
120 input/output unit
130 memory unit
131 storage form
132 storage work
133 work-related information
134 storage form-object type
135 object type
136 storage work-object type
137 object-related information
138 stage

1. A storage work support device, comprising:
a storage work information acquisition unit configured to acquire storage work information including one or more pieces of storage work;
a type associating unit configured to associate a type of an object that becomes a target of storage work with the storage work information;
a storage work associating unit configured to associate storage work included in the storage work information associated with the type of the object with the object as storage work for the object;
a receipt date acquisition unit configured to acquire a date on which the object has been received; and
a notification unit configured to notify a schedule of execution of the storage work associated with the object in accordance with the date acquired by the receipt date acquisition unit.

2. The storage work support device according to claim 1, wherein the notification unit is configured to notify information indicating the storage work together with the schedule.

3. The storage work support device according to claim 1,
wherein the type associating unit is configured to associate a storage place of the object that becomes the target of the storage work with the storage work information, and
wherein the storage work associating unit is configured to associate the storage work included in the storage work information associated with the storage place of the object with the object as the storage work for the object.

4. The storage work support device according to claim 3, wherein the type associating unit and the storage work associating unit are configured to switch associating in accordance with whether the object that becomes the target of the storage work has information relating to an attachment position at a construction site.

5. The storage work support device according to claim 1, further comprising an extraction unit configured to extract, when a predetermined timing is specified, storage work to be executed at the specified predetermined timing and the object for which the storage work is to be executed.

6. The storage work support device according to claim 1,
wherein the storage work support device further comprises an execution result acquisition unit configured to acquire an execution result of storage work,
wherein the execution result includes a storage state of the object, and
wherein the storage work support device further comprises a tracking unit configured to track the object having the storage state being a specific state.

7. A storage work support method, comprising:
a storage work information acquisition step of acquiring storage work information including one or more pieces of storage work;
a type associating step of associating a type of an object that becomes a target of storage work with the storage work information;
a storage work associating step of associating storage work included in the storage work information associated with the type of the object with the object as storage work for the object;
a receipt date acquisition step of acquiring a date on which the object has been received; and
a notification step of notifying a schedule of execution of the storage work associated with the object in accordance with the date acquired in the receipt date acquisition step.

8. A program for causing a computer to function as:
a storage work information acquisition unit configured to acquire storage work information including one or more pieces of storage work;
a type associating unit configured to associate a type of an object that becomes a target of storage work with the storage work information;
a storage work associating unit configured to associate storage work included in the storage work information associated with the type of the object with the object as storage work for the object;
a receipt date acquisition unit configured to acquire a date on which the object has been received; and
a notification unit configured to notify a schedule of execution of the storage work associated with the object in accordance with the date acquired by the receipt date acquisition unit.
